(19) United States
(12) Patent Application Publication
(10) Pub. No.: US 2026/0338310 A1
(43) Pub. Date: Oct. 29, 2026

(54) ISOLATING AND CANCELLING NOISE IN PIPE SYSTEMS

(71) Applicant: Saudi Arabian Oil Company, Dhahran (SA)

(72) Inventors: Ali J. Alrasheed, Edmonton (CA); Sahejad Patel, Thuwal (SA); Amjad Felemban, Thuwal (SA); Fadl Abdellatif, Thuwal (SA); Aziz U. Rehman, Edmonton (CA); Meshal M. Alalwani, Dammam (SA); Yousef Damanhouri, Thuwal (SA); Ibrahim S. Alsalamah, Thuwal (SA)

(21) Appl. No.: 19/187,677

(22) Filed: Apr. 23, 2025

(51) Int. Cl. F16L 55/033; G10K 11/178; G01H 11/08

(52) U.S. Cl. CPC F16L 55/0333; G10K 11/17881; G01H 11/08

(57) ABSTRACT

System and method for performing noise isolation and cancellation in pipe systems in oil and gas plants. An example system can receive leakage emission data from the piezoelectric sensor configured to be attached to a pipe and detect acoustic emissions from a valve; receive external noise data from the one or more acoustic sensors configured to capture ambient noise; estimate a valve signal using the leakage emission data; estimate an external noise signal using the external noise data; apply phase and amplitude adjustments to the external noise signal to generate an anti-noise signal; combine the external noise signal and the anti-noise signal to generate a composite signal; and subtract the composite signal from the valve signal to generate a corrected valve signal.

### TECHNICAL FIELD

The present disclosure relates to methods and systems for noise isolation and cancellation in pipe systems.

### BACKGROUND

Acoustic devices used to sense physical phenomena often encounter significant difficulties due to the presence of surrounding environmental noise. This noise can distort the detected signals leading to inaccurate measurements and compromised performance, which affects final reporting and decision making regarding the integrity status of the object being inspected or maintained (for example, a leaking valve that needs replacement).

### SUMMARY

This disclosure describes systems and methods for noise isolation and cancellation in pipe systems in oil and gas plants. A piezoelectric sensor is configured to be attached to a pipe and detect acoustic emissions from a valve. One or more acoustic sensors are configured to capture ambient noise. An enclosure wall surrounds the piezoelectric sensor One or more processors are communicatively coupled to the piezoelectric sensor and the set of acoustic sensors and a computer readable medium stores instructions that when executed cause the one or more processors to perform operations comprising: receiving leakage emission data from the piezoelectric sensor; receiving external noise data from the one or more acoustic sensors; estimating a valve signal using the leakage emission data; estimating an external noise signal using the external noise data; applying phase and amplitude adjustments to the external noise signal to generate an anti-noise signal; combining the external noise signal and the anti-noise signal to generate a composite signal; and subtracting the composite signal from the valve signal to generate a corrected valve signal.

In some implementations, the piezoelectric sensor is a first piezoelectric sensor, and the one or more acoustic sensors are second piezoelectric sensors.

In some implementations, the one or more acoustic sensors are placed on an inner perimeter of the enclosure wall.

In some implementations, the one or more acoustic sensors are placed on an outer perimeter of the enclosure wall.

In some implementations a first subset of the one or more acoustic sensors is placed on the inner perimeter of the enclosure wall and a second subset of the one or more acoustic sensors is placed on the outer perimeter of the enclosure wall.

In some implementations, the system further comprises an outer enclosure wall that surrounds the enclosure wall.

In some implementations, the one or more acoustic sensors are placed on the inner perimeter of the outer enclosure wall.

In some implementations, the one or more acoustic sensors are placed on the outer perimeter of the outer enclosure wall.

In some implementations, a first subset of the one or more acoustic sensors is placed on the inner perimeter of the outer enclosure wall and a second subset of the one or more acoustic sensors is placed on the outer perimeter of the outer enclosure wall.

In some implementations, the system further comprises an acoustic barrier placed between the enclosure wall and the outer enclosure wall configured to isolate the piezoelectric sensor.

In some implementation, the acoustic barrier is a foaming material.

In some implementations, the system further comprises a vacuum chamber placed between the enclosure wall and the outer enclosure wall configured to reduce external noise and sound vibrations.

In some implementations, estimating an external noise signal using the external noise data comprises using a digital signal processor to estimate statistical properties of the external noise signal.

In some implementations applying phase and amplitude adjustments to the external noise signal to generate an anti-noise signal comprises generating the anti-noise signal in a frequency domain.

In some implementations, the system further comprises an adjustable spring mechanism configured to dampen noise vibrations, a motor configured to control the length of the spring, and a feedback loop configured to find a length of the spring that has a highest dampening of noise vibrations.

Implementations of the systems and methods of this disclosure can provide various technical benefits. For example, implementations according to the present disclosure can increase an accuracy of detection of a target phenomena, such as noise generated by a valve or fluid flow or other target phenomena, by eliminating external noise effects. As another example, implementations according to the present disclosure can use an integrated software and hardware system that can actively eliminate the effects of external noise.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIGS. 1A, 1B, 1C, 1D, 1E, 1F and 1G, illustrate example configurations for a noise management system.

FIG. 2 shows an example biasing member in a noise management system.

FIG. 3 is a flow chart for an example method for cancelling ambient noise in a pipe system.

FIG. 4 is a block diagram of an example computer system, according to some implementations.

Like reference symbols in the various drawings indicate like elements.

### DETAILED DESCRIPTION

This disclosure describes systems and methods for noise isolation and cancellation in pipe systems. A piezoelectric sensor can be configured to couple to a pipe near a valve. A set of acoustic sensors can be arranged to capture ambient noise near the piezoelectric sensor. The piezoelectric sensor and acoustic sensors are communicatively coupled to a data processing system. The data processing system receives leakage emission data from the set of piezoelectric sensors and external noise data from the acoustic sensors, estimates a valve signal and an external noise signal, generates an anti-noise signal, and generates a corrected valve signal.

The piezoelectric sensor can be coupled to a variety of pipe sizes and types. Because the piezoelectric sensor and noise management system do not protrude into the pipe, the noise management system provides flexibility in installing the piezoelectric sensor near valves.

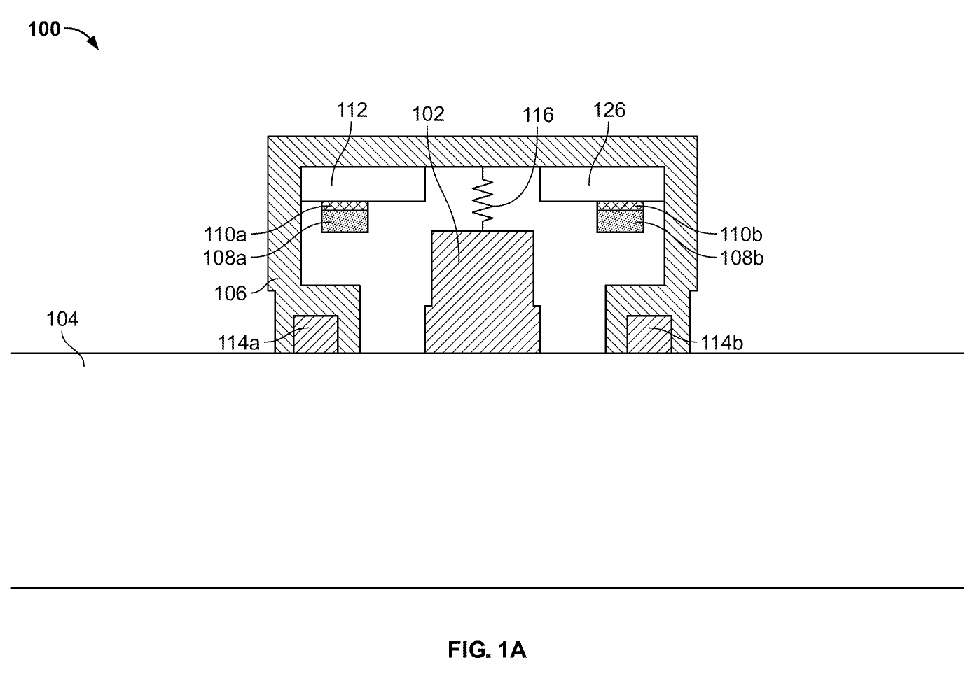

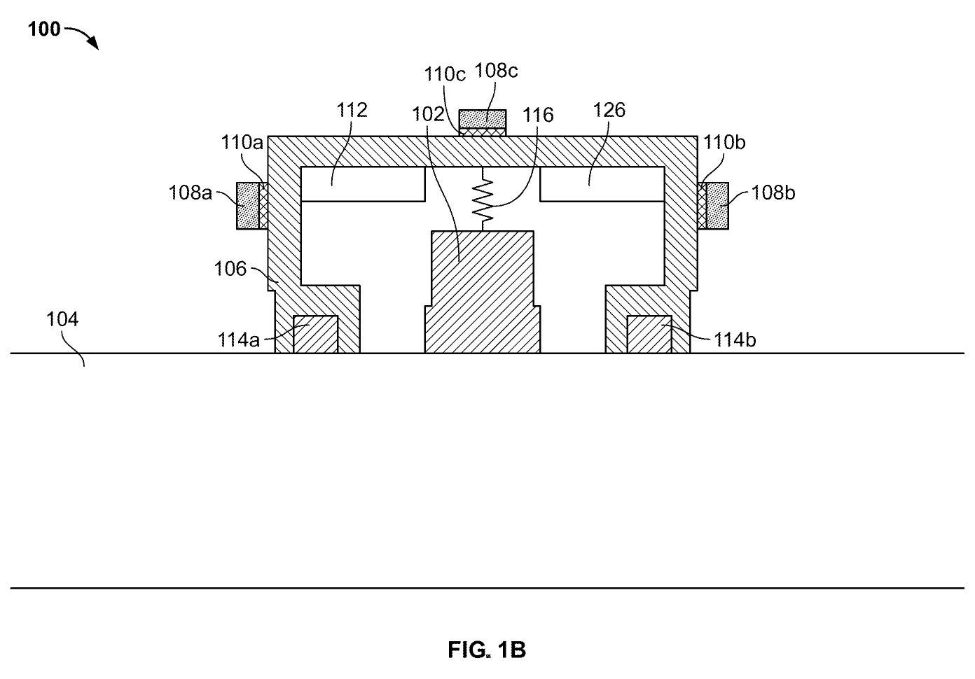

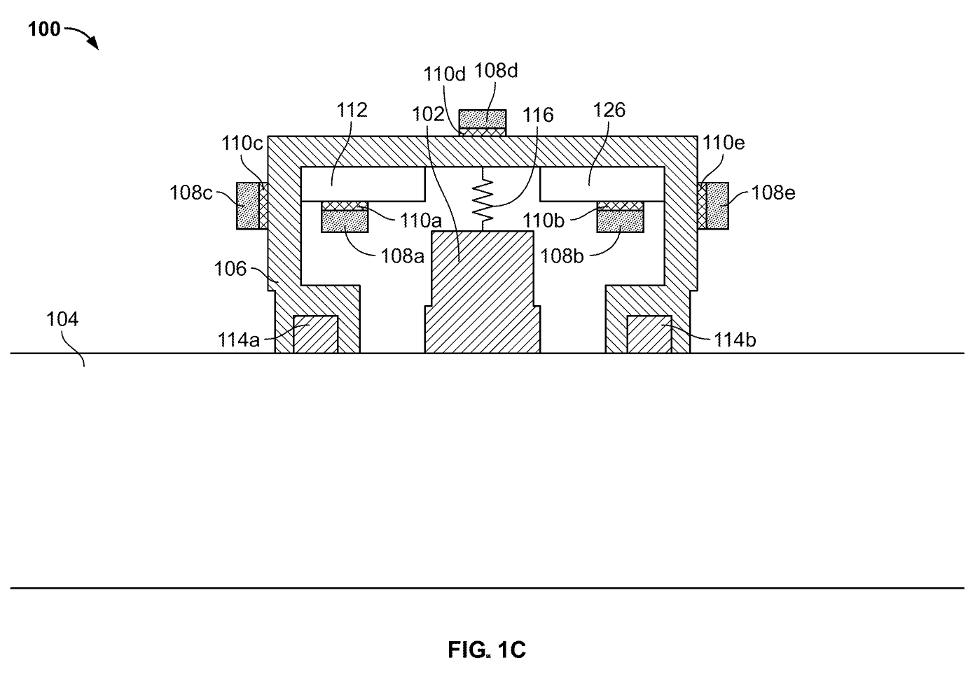

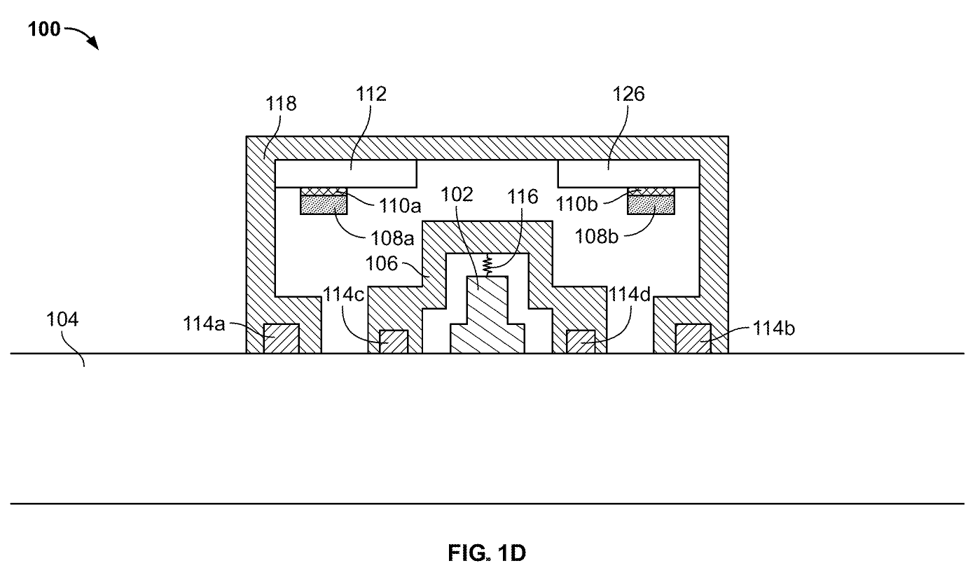

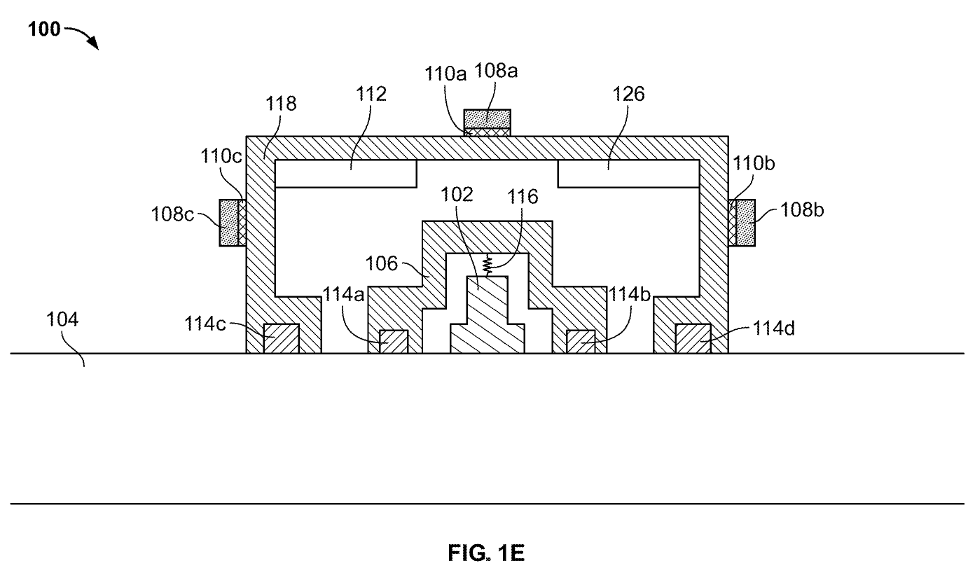

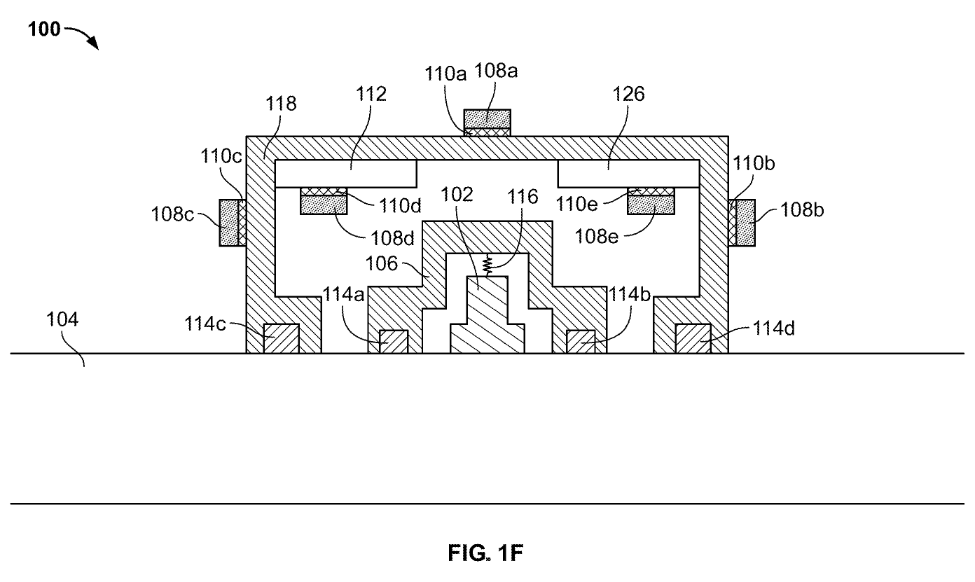

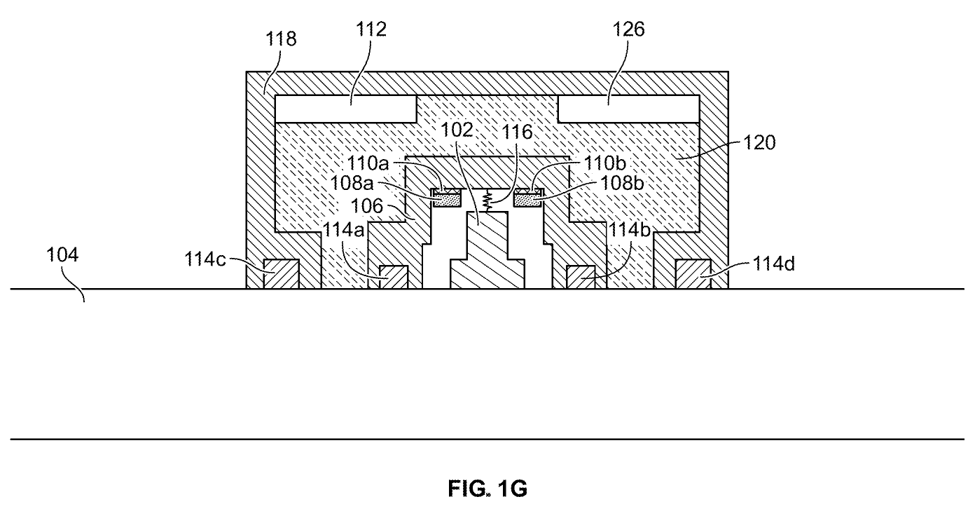

FIGS. 1A, 1B, 1C, 1D, 1E, 1F and 1G, illustrate example configurations for a noise management system 100, according to the present disclosure.

In some implementations, the noise management system 100 can include a noise enclosure that is coupled to (e.g., detachably engaged with) a pipeline 104 that carries a fluid therethrough. In some examples, the fluid can represent a noise source that is desired to be measured or monitored, as the fluid can create noise during circulation (or otherwise). In other examples, noise sources can include valves or other mechanical devices.

A piezoelectric sensor 102 can be mounted to (attached or otherwise in contact with) a wall of the pipeline 104 and operable to measure the noise. In some examples, the pipeline 104 can be a portion of or an entire flare gas pipeline in a hydrocarbon fluid system. It is desirable to monitor noise in such a system because unintentional passing of gases to a flare system in oil and gas plants is a common issue that can result in significant business losses and environmental impacts. In these plants, gases that are produced during the oil and gas production processes are often burned off in a flare system to reduce the amount of gas that is released into the atmosphere. However, when the gases are not meant to be burned, burning them can result in a significant loss of valuable resources. In addition to business losses, unintentional passing of gases to the flare system can also be detrimental to the environment. The gases that escape into the atmosphere can contribute to air pollution and may also contribute to the greenhouse effect and global warming, as they trap heat in the atmosphere and contribute to the warming of the planet.

Noise can be measured or monitored to detect the unintentional passing, which minimizes the risk of unintended gas releases. This, in turn, prevents the loss of valuable hydrocarbon and decreases the detrimental effects to the environment. Piezoelectric sensors are acoustic sensors that can be used to detect noise associated with, for example, fluid flow, the passing of valves, and other noise-creating events associated with a flare gas system. These sensors utilize the piezoelectric effect, where certain materials generate an electric charge when subjected to mechanical stress. In the context of valve detection, for example, piezoelectric sensors are typically placed in close proximity to the valve or its housing. When a valve opens or closes, the resulting mechanical vibrations or pressure changes are picked up by the piezoelectric sensor, causing it to generate an electrical signal. The sensitivity and responsiveness of piezoelectric sensors make them well‐suited for detecting the passing of valves, enabling precise monitoring and control in a wide range of industries, including automotive, oil and gas, and fluid systems.

However, piezoelectric sensors, like many acoustic devices, are susceptible to error caused by environmental noise (for example, noise not associated with the passing of a valve, circulation of fluid, or other noise effect to be measured), which reduces the accuracy of these sensors.

In some implementations, the noise management system 100 can include an enclosure wall 106 that surrounds the piezoelectric sensor 102. The enclosure wall 106 can provide environmental protection to the piezoelectric sensor 102. In some examples, the enclosure wall 106 can be made of a unitary material. The material can be selected to further enhance passive noise reduction of the environmental noise within the enclosure wall. Example materials include rigid materials, like SonoPan, drywall, Medium-Density Fiberboard (MDF), and plywood, among others.

In some implementations, the enclosure wall 106 can include an inner wall structure and an outer wall structure that are formed of different materials. For example, a layer or coating can be applied on the enclosure wall 106 as either the inner wall structure or outer wall structure (or both). In some examples, such a layer or coating is the same for the inner wall structure and outer wall structure. Alternatively, the layer or coating can be different for the inner wall structure and outer wall structure. The rigid materials exemplified herein can be used for the inner wall structure or outer wall structure (or both). In some examples, flexible materials, such as foam, Mass Loaded Vinyl (MLV), rockwool, or a fiberglass (or other) insulation can be used as a layer or coating of the inner wall structure or outer wall structure (or both). In some examples, an applicable material, such as Quiet Glue or Green Glue can be applied a layer or coating of the inner wall structure or outer wall structure (or both).

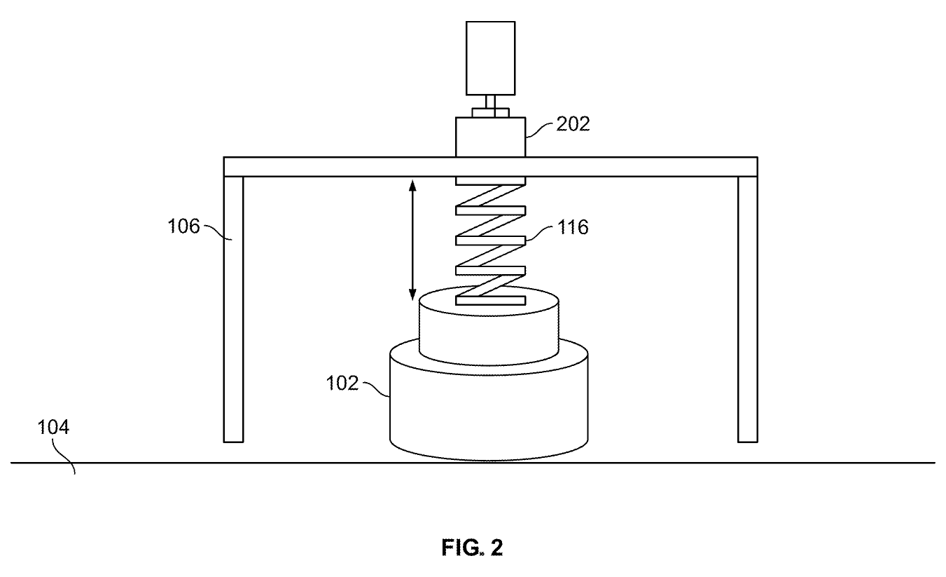

The enclosure wall 106 can be coupled to or attached to the pipeline 104 with one or more magnets 114a and 114b. In alternative implementations, mechanical fasteners or adhesives can be used to couple or attach the enclosure wall 106 to the pipeline 104. In so attaching, the piezoelectric sensor 102 is also acoustically coupled (for example, through contact) to the pipeline 104. In some examples, a biasing member 116 (such as a spring) is attached to the piezoelectric sensor 102 from the enclosure wall 106 to urge the piezoelectric sensor into contact with the pipeline 104 to improve noise sensing and increase a contact area (and reduce an airgap) between the piezoelectric sensor 102 and the pipeline 104. The biasing member 116 is described in further detail below with reference to FIG. 2.

The noise management system 100 can include one or more energy storage devices 112 (such as NiMH batteries or otherwise) and a control circuit 126 (such as a printed circuit board or other form of processing unit) within the enclosure wall 106. In example aspects, the one or more energy storage devices 112 are electrically coupled to the control circuit 126 to provide electrical power thereto.

The noise management system 100 can include a set of one or more acoustic sensors 108a-e configured to capture ambient noise. The noise management system 100 can include any appropriate number of acoustic sensors, e.g., 1, 3, 5, 8, etc. The acoustic sensors 108a-e can each be attached with the enclosure wall using a respective magnet 110a-e. The acoustic sensors can be, for example, piezoelectric sensors, microphones, etc. In some examples, the acoustic sensors can all be of the same type. The acoustic sensors can be placed in the noise management system 100 in a variety of configurations.

In FIG. 1A, two acoustic sensors 108a and 108b are placed on an inner perimeter of the enclosure wall 106. The acoustic sensors 108a and 108b are attached to the enclosure wall using respective magnets 110a and 110b. The energy storage device 112 and the control circuit 126 connect to the inner perimeter of the enclosure wall 106. One acoustic sensor 108a is attached to the energy storage device 112 and the other acoustic sensor 108b is attached to the control circuit 126.

In FIG. 1B, three acoustic sensors 108a, 108b, and 108c are placed on an outer perimeter of the enclosure wall 106. The acoustic sensors 108a, 108b, and 108c are attached to the enclosure wall using respective magnets 110a, 110b, and 110c. Each acoustic sensor 108a, 108b, and 108c can be placed on a different side (e.g., left, top, right) of the enclosure wall 106.

In FIG. 1C two acoustic sensors 108a and 108e are placed on an inner perimeter of the enclosure wall 106 and three acoustic sensors 108b, 108c, and 108d are placed on an outer perimeter of the enclosure wall. The acoustic sensors 108a, 108b, 108c, 108d, and 108e are attached to the enclosure wall using respective magnets 110a, 110b, 110c, 110d, and 110e.

In some examples, the noise management system can include an outer enclosure wall 118 that surrounds the enclosure wall 106. The outer enclosure wall 118 can provide additional environmental protection to the piezoelectric sensor 102. In some examples, the outer enclosure wall 118 can be made of a unitary material. In some examples, the material can be selected to further enhance passive noise reduction of the environmental noise within the enclosure wall. Examples of such rigid materials include SonoPan, drywall, MDF, and plywood, among others.

In alternative examples, the outer enclosure wall 118 can include an inner wall structure and an outer wall structure that are formed of different materials. For example, a layer or coating can be applied on the outer enclosure wall 118 as either the inner wall structure or outer wall structure (or both). In some examples, such a layer or coating is the same for the inner wall structure and outer wall structure; alternatively, the layer or coating can be different for the inner wall structure and outer wall structure. The rigid materials exemplified herein can be used for the inner wall structure or outer wall structure (or both). In some examples, flexible materials, such as foam, MLV, rockwool, or a fiberglass (or other) insulation can be used as a layer or coating of the inner wall structure or outer wall structure (or both). In some examples, an applicable material, such as Quiet Glue or Green Glue can be applied a layer or coating of the inner wall structure or outer wall structure (or both).

The outer enclosure wall 118 can be coupled to or attached to the pipeline 104 with one or more magnets 114c and 114d. In alternative implementations, mechanical fasteners or adhesives can be used to couple or attach the outer enclosure wall 118 to the pipeline 104.

In FIG. 1D, two acoustic sensors 108a and 108b are placed on an inner perimeter of the outer enclosure wall 118. The acoustic sensors 108a and 108b are attached to the outer enclosure wall using respective magnets 110a and 110b. The energy storage device 112 and the control circuit 126 connect to the inner perimeter of the outer enclosure wall 118. One acoustic sensor 108a is attached to the energy storage device 112 and the other acoustic sensor 108b is attached to the control circuit 126.

In FIG. 1E, three acoustic sensors 108a, 108b, and 108c are placed on an outer perimeter of the outer enclosure wall 118. The acoustic sensors 108a, 108b, and 108c are attached to the outer enclosure wall using respective magnets 110a, 110b, and 110c. Each acoustic sensor 108a, 108b, and 108c can be placed on a different side (e.g., left, top, right) of the outer enclosure wall 106.

In FIG. 1F, two acoustic sensors 108d and 108e are placed on an inner perimeter of the outer enclosure wall 118 and three acoustic sensors 108a, 108b, and 108c are placed on an outer perimeter of the outer enclosure wall. The acoustic sensors 108a, 108b, 108c, 108d, and 108e are attached to the outer enclosure wall using respective magnets 110a, 110b, 110c, 110d, and 110e.

In some examples, the noise management system 100 can include further noise dampening mechanisms. The noise management system 100 can include a vacuum or introduce an acoustic barrier to surround the acoustic device to further attenuate environmental noise. An acoustic barrier can include, for example, a foaming material to further isolate the piezoelectric sensor 102. A vacuum can reduce external noise and sound vibrations to pass through to the element. A vacuum can be created by, for example, sucking air using a compressor tool. The vacuum or acoustic barrier allows for more concise and clear readings to be collected of the pipe.

In FIG. 1G an acoustic barrier 120 is places between the enclosure wall 106 and the outer enclosure wall 118. The energy storage device 112 and the control circuit 126 connect to the inner perimeter of the outer enclosure wall 118. Two acoustic sensors 108a and 108b are placed on an inner perimeter of the enclosure wall 106. This reduces external noise processed by the piezoelectric sensor 102.

In some implementations, the control circuit 126 can include appropriate computing hardware including one or more hardware processors, one or more interconnected memory modules, data connections, etc. The control circuit 126 can communicate over one or more data networks with the piezoelectric sensor 102 and the one or more acoustic sensors 108a-e. The control circuit can output a corrected noise signal that does not include external noise.

The control circuit 126 can receive leakage emission data from the piezoelectric sensor 102 and external noise data from the set of acoustic sensors 108a-e. The leakage emission data can include time-series data collected from the piezoelectric sensors 102. Similarly, the external noise data can include time-series data collected from the acoustic sensors 108a-e.

The control circuit 126 can estimate a valve signal using the leakage emission data. The leakage emission data can be stored as data indicating an amplitude of the leakage emission at an associated time. In some implementations, the leakage emission data can include a frequency domain representation of the valve signal. For example, the leakage emission data can include frequencies identified in the valve signal and the magnitude of the identified frequencies.

The control circuit 126 can estimate time domain features and/or frequency domain features of the valve signal. Time domain features include, for example, a root mean square (RMS) of the leakage emission data that give a measure of the magnitude of the valve signal and zero-crossing rate which counts the number of times that the leakage emission data changes from a positive value to a negative value or vice versa. Frequency domain features can include, for example, spectral roll-off, spectral bandwidth, frequency with maximum amplitude, and frequency with maximum time averaged amplitude. Spectral roll off is a measure of the shape of the power spectrum of the leakage emission data. In particular, it measures the frequency at which high frequencies decline to zero. Spectral Bandwidth is a weighted mean of the distances of frequency bands form the spectral centroid. Frequency value with maximum amplitude and frequency value with maximum time-average amplitude can be determined based on a spectrogram representing the leakage emission data.

The control circuit 126 can estimate an external noise signal using the external noise data. The external noise data can be stored as data indicating an amplitude of the external noise data at an associated time. The control circuit can use a digital signal processor to estimate statistical properties (e.g., frequency content, amplitude, and phase) of the ambient noise. The digital signal processor can estimate time domain features and frequency domain features of the external noise data.

The control circuit 126 can apply phase and amplitude adjustments to the external noise signal to generate an anti-noise signal. The anti-noise signal can be generated to be 180 degrees out-of-phase with the external noise signal. The amplitudes of the anti-noise signal can be identical to the external noise signal. When the anti-noise signal is 180 degrees out-of-phase (a half-cycle delay) with the external noise signal such that as the external noise signal rises the anti-noise signal falls, the anti-noise signal can counteract the external noise signal. When combined, the external noise signal can be cancelled out by the anti-noise signal. The control circuit 126 can combine the external noise signal and the anti-noise signal to generate a composite signal. The control circuit 126 can subtract the composite signal from the valve signal to generate a corrected valve signal. The corrected valve signal is not affected by the ambient noise as the composite effectively cancels out the external noise.

In some examples, the control circuit 126 can generate the anti-noise signal in a frequency domain. This can be done by employing algorithms such as Fast Fourier Transform (FFT), Adaptive Filters, averaging, and other techniques to analyze ambient sounds and generate opposing signals.

FIG. 2 shows an example biasing member in a noise management system. The biasing member can be, for example, the biasing member 116 of FIGS. 1A-1G.

In this example, the biasing member 116 is a spring. The biasing member 116 can counteract noise from the vibration of structure itself e.g., the pipe 104. This noise can affect the signal of the piezoelectric sensor 102 but cannot be removed by cancelling out noise detected by the acoustic sensors meant to detect ambient noise.

To counteract the physical vibration of the pipe against the piezoelectric sensor 102, the biasing member 116 can be an adjustable motorized spring mechanism. The spring is attached to a motor 202. The spring can act as a dampener to the vibrations from the pipe 104 and the motor 202 can change the length of the spring to find the most appropriate spring stiffness to dampen the vibrations as much as possible. The motor 202 is connected to a feedback loop.

The feedback loop can use, for example, a displacement sensor, a force sensor, a controller, and an actuator to regulate the force applied to the spring. By iteratively adjusting the force and measuring the resulting displacement, the feedback loop calculates the spring stiffness e.g., by using Hooke's Law. This allows the motor 202 to continuously monitor and adjust the spring's 116 stiffness to optimize its ability to counteract vibrations and ensure accurate measurements from the piezoelectric sensor 102.

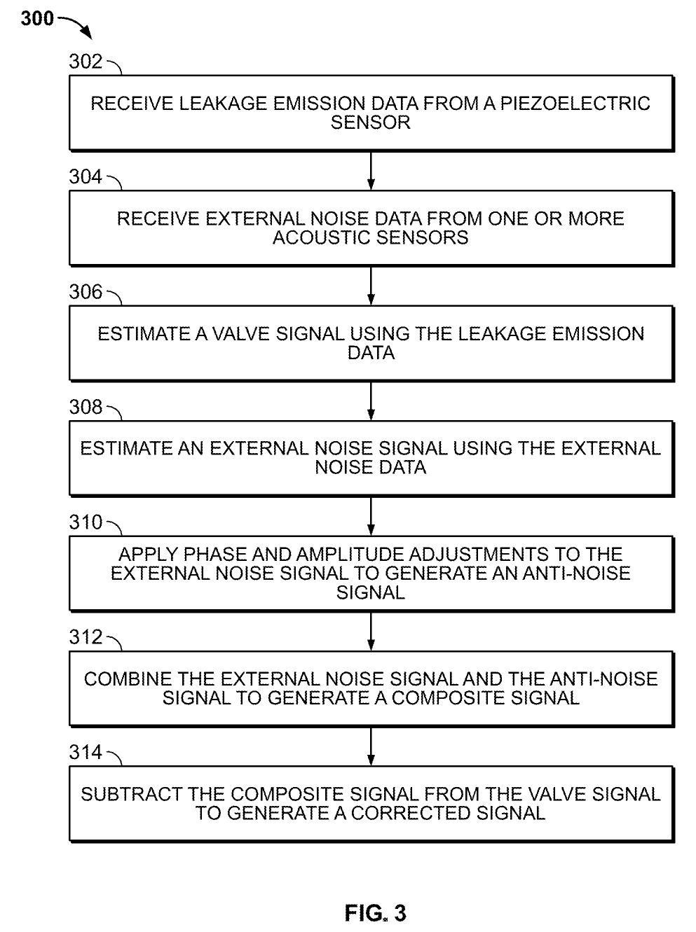

FIG. 3 is a flow chart for an example method 300 for cancelling ambient noise in a pipe system. The method 300 can be implemented on a data processing system such as a computer or control system (e.g., control circuit 106). In some examples, the method 300 is implemented on one or more processors included in a sensor device (e.g., piezoelectric sensor 102) attached to a pipe, thereby enabling the method to be executed on-the-edge (e.g., near the point of data collection). In other examples, the data processing system is separate from the sensor device.

The data processing system receives leakage emission data from the piezoelectric sensor (step 302). The piezoelectric sensor can include integrated electronics to measure the leakage emissions and process the measured data without communicating with a computing system external to the sensor and its associated electronics. The piezoelectric sensor can be coupled to a pipe near a valve of interest. For example, the sensor can be attached to a pipe with magnets at a location on the downstream side of a valve. Magnetically attaching the sensor to the pipe can enhance the acoustic emission readings by reducing measurements of ambient noise. The sensor can be sensitive to vibrations from the valve. In implementations having non-magnetic pipes, the sensor can be coupled to the pipe through other means such as clamps, bolts, and/or zip-ties. The sensors can be communicatively coupled with other computing devices to transmit and receive data such as passing valve detection alerts and sensor status. In some implementations, the data processing system acquires the acoustic emission data from a data store storing data previously acquired from a piezoelectric sensor.

The data processing system receives external noise data from one or more acoustic sensors (step 304). The acoustic sensor can be configured to capture ambient noise. In some implementations, the acoustic sensors are piezoelectric sensors.

The data processing system estimates a valve signal using the leakage emission data (step 306). The valve signal can be estimated using time-domain features, frequency domain features, or a combination thereof derived from statistical analysis of the leakage emission data.

The data processing system estimates an external noise signal using the external noise data (step 308). The external noise signal can be estimated using time-domain features, frequency domain features, or a combination thereof derived from statistical analysis of the external noise data. In some implementations, the data processing system uses a digital signal processor to estimate statistical properties of the ambient noise.

The data processing system applies phase and amplitude adjustments to the external noise signal to generate an anti-noise signal (step 310). In some implementations, the data processing system can generate the anti-noise signal in a frequency domain using techniques including Fast Fourier Transform (FFT), Adaptive Filters, averaging, etc.

The data processing system combines the external noise signal and the anti-noise signal to generate a composite signal (step 312).

The data processing system subtracts the composite signal from the valve signal to generate a corrected valve signal (step 314). The corrected valve signal does not include the ambient noise.

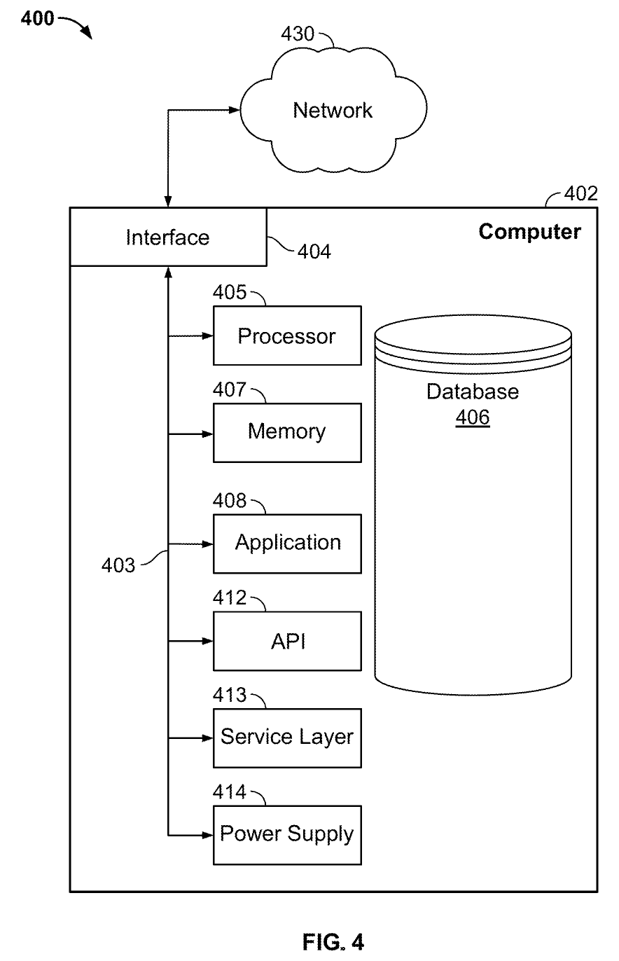

FIG. 4 is a block diagram of an example computer system 400 that can be used to provide computational functionalities associated with described algorithms, methods, functions, processes, flows, and procedures, according to some implementations of the present disclosure. In some implementations, the control circuit 126 can be the computer system 400, include the computer system 400, or the control circuit 126 can communicate with the computer system 400.

The illustrated computer 402 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 402 can include a Smart Embedded Management Agent (SEMA), such as a built-in ADLINK SEMA 2.2, and a video sync technology, such as Quick Sync Video technology supported by ADLINK MSDK+. In some examples, the computer 402 can include the MXE-5400 Series processor-based fanless embedded computer by ADLINK, though the computer 402 can take other forms or include other components.

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a high level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both), over the system bus. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs 412.

The service layer 413 can provide software services to the computer 402 and other components (whether illustrated or not) that are communicably coupled to the computer 402. The functionality of the computer 402 can be accessible for all service consumers using this service layer 413. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 can include an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and manipulate data to perform the operations of the computer 402, including operations using algorithms, methods, functions, processes, flows, and procedures as described in the present disclosure.

The computer 402 can also include a database 406 that can hold data for the computer 402 and other components connected to the network 430 (whether illustrated or not). For example, database 406 can be an in-memory, conventional, or a database storing data consistent with the present disclosure. In some implementations, the database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

An application 408 can be an algorithmic software engine providing functionality according to particular needs, desires, or particular implementations of the computer 402 and the described functionality. For example, an application 408 can serve as one or more components, modules, or applications 408. Multiple applications 408 can be implemented on the computer 402. Each application 408 can be internal or external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system including computer 402, with each computer 402 communicating over network 430. Further, the terms “client,” “user,” and other appropriate terminology can be used interchangeably without departing from the scope of the present disclosure. Moreover, the present disclosure contemplates that many users can use one computer 402 and one user can use multiple computers 402.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network ("LAN"), a wide area network ("WAN"), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A system for performing noise isolation and cancellation in pipe systems in oil and gas plants, the system comprising:
a piezoelectric sensor configured to be attached to a pipe and detect acoustic emissions from a valve;
one or more acoustic sensors configured to capture ambient noise;
an enclosure wall that surrounds the piezoelectric sensor; and
one or more processors communicatively coupled to the piezoelectric sensor and the set of acoustic sensors and a computer readable medium storing instructions that when executed cause the one or more processors to perform operations comprising:
receiving leakage emission data from the piezoelectric sensor;
receiving external noise data from the one or more acoustic sensors;
estimating a valve signal using the leakage emission data;
estimating an external noise signal using the external noise data;
applying phase and amplitude adjustments to the external noise signal to generate an anti-noise signal;
combining the external noise signal and the anti-noise signal to generate a composite signal; and
subtracting the composite signal from the valve signal to generate a corrected valve signal.

2. The system of claim 1, wherein the piezoelectric sensor is a first piezoelectric sensor, and wherein the one or more acoustic sensors are second piezoelectric sensors.

3. The system of claim 1, wherein the one or more acoustic sensors are placed on an inner perimeter of the enclosure wall.

4. The system of claim 1, wherein the one or more acoustic sensors are placed on an outer perimeter of the enclosure wall.

5. The system of claim 1, wherein a first subset of the one or more acoustic sensors is placed on the inner perimeter of the enclosure wall and a second subset of the one or more acoustic sensors is placed on the outer perimeter of the enclosure wall.

6. The system of claim 1, the system further comprising:
an outer enclosure wall that surrounds the enclosure wall.

7. The system of claim 6, wherein the one or more acoustic sensors are placed on the inner perimeter of the outer enclosure wall.

8. The system of claim 6, wherein the one or more acoustic sensors are placed on the outer perimeter of the outer enclosure wall.

9. The system of claim 6, wherein a first subset of the one or more acoustic sensors is placed on the inner perimeter of the outer enclosure wall and a second subset of the one or more acoustic sensors is placed on the outer perimeter of the outer enclosure wall.

10. The system of claim 6, the system further comprising:
an acoustic barrier placed between the enclosure wall and the outer enclosure wall configured to isolate the piezoelectric sensor.

11. The system of claim 10, wherein the acoustic barrier is a foaming material.

12. The system of claim 6, the system further comprising:
a vacuum chamber placed between the enclosure wall and the outer enclosure wall configured to reduce external noise and sound vibrations.

13. The system of claim 1, wherein estimating an external noise signal using the external noise data comprises using a digital signal processor to estimate statistical properties of the external noise signal.

14. The system of claim 1, wherein applying phase and amplitude adjustments to the external noise signal to generate an anti-noise signal comprises generating the anti-noise signal in a frequency domain.

15. The system of claim 1, the system further comprising:
an adjustable spring mechanism configured to dampen noise vibrations;
a motor configured to control the length of the spring; and
a feedback loop configured to find a length of the spring that has a highest dampening of noise vibrations.

16. A method for performing noise isolation and cancellation in pipe systems in oil and gas plants, the method comprising:
receiving leakage emission data from a piezoelectric sensor configured to be attached to a pipe and detect acoustic emissions from a valve;
receiving external noise data from the one or more acoustic sensors configured to capture ambient noise;
estimating a valve signal using the leakage emission data;
estimating an external noise signal using the external noise data;
applying phase and amplitude adjustments to the external noise signal to generate an anti-noise signal;
combining the external noise signal and the anti-noise signal to generate a composite signal; and
subtracting the composite signal from the valve signal to generate a corrected valve signal.

17. The method of claim 16, wherein the piezoelectric sensor is a first piezoelectric sensor, and wherein the one or more acoustic sensors are second piezoelectric sensors.

18. The method of claim 16, wherein estimating an external noise signal using the external noise data comprises using a digital signal processor to estimate statistical properties of the external noise signal.

19. The method of claim 16, wherein applying phase and amplitude adjustments to the external noise signal to generate an anti-noise signal comprises generating the anti-noise signal in a frequency domain.

20. The method of claim 16, wherein an enclosure wall surrounds the piezoelectric sensor.
